(19) United States
(12) Patent Application Publication
(10) Pub. No.: US 2024/0037432 A1
(43) Pub. Date: Feb. 1, 2024

(54) QUANTUM COMPUTING NETWORK WITH PHYSICAL MESH SERVICE

(71) Applicant: Red Hat, Inc., Raleigh, NC (US)

(72) Inventors: Stephen Coady, Waterford (IE); Leigh Griffin, Waterford (IE)

(21) Appl. No.: 17/874,605

(22) Filed: Jul. 27, 2022

(51) Int. Cl. G06N 10/20

(52) U.S. Cl. CPC G06N 10/20

(57) ABSTRACT

Examples relating to quantum computing networks are provided. In one example, data indicative of a quantum computing device joining a quantum computing network is received. A plurality of quantum simulator nodes are generated for the quantum computing device. Each quantum simulator node simulates one of a plurality of different operating states of the quantum computing device. Each of the quantum simulator nodes is stored as an execution node of the quantum computing network for execution of a quantum service.

### BACKGROUND

Quantum computing involves the use of quantum bits, referred to herein as “qubits,” which have characteristics that differ from those of classical (i.e., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

### SUMMARY

The examples disclosed herein relate to a quantum computing network that includes one or more quantum computing devices and includes one or more classical quantum simulator nodes simulating an operating state of a quantum computing device. In one example, a method includes receiving, by one or more computing devices, data indicative of a quantum computing device joining a quantum computing network. The method includes generating, by the one or more computing devices, a plurality of quantum simulator nodes for the quantum computing device, each of the plurality of quantum simulator nodes to simulate one of a plurality of different operating states of the quantum computing device. The method includes storing, by the one or more computing devices, each of the plurality of quantum simulator nodes as an execution node of the quantum computing network to execute a quantum service.

In another example, a computing device includes a memory. The computing device includes a processor device coupled to the memory to receive a request to execute a quantum service. The processor device is to access a quantum computing network for execution of the quantum service. The quantum computing network includes a plurality of quantum computing devices and a plurality of quantum simulator nodes. Each quantum simulator node simulates a different operating state for one of the plurality of quantum computing devices. The plurality of quantum computing devices and the plurality of quantum simulator nodes are each an execution node of the quantum computing network. The processor device is to determine a selected execution node of the plurality of execution nodes to execute the quantum service based at least in part on an operating state associated with the selected execution node. The processor device is to obtain a result for the quantum service executed at the selected execution node.

In another example, a non-transitory computer-readable storage medium has stored thereon computer-executable instructions that, when executed, cause one or more processor devices to: receive data indicative of a quantum computing device joining a quantum computing network; generate a plurality of quantum simulator nodes for the quantum computing device, each of the plurality of quantum simulator nodes to simulate one of a plurality of different operating states of the quantum computing device; and store each of the plurality of quantum simulator nodes as an execution node of the quantum computing network to execute a quantum service.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts an example system implementing a quantum computing network according to example implementations of the present disclosure.

FIG. 2 depicts a flow chart of an example method according to example implementations of the present disclosure.

FIG. 3 depicts a flow chart of an example method according to example implementations of the present disclosure.

FIG. 4 depicts a flow chart of an example method according to example implementations of the present disclosure.

FIG. 5 depicts a flow chart of an example method according to example implementations of the present disclosure.

FIG. 6 depicts a flow chart of an example method according to example implementations of the present disclosure.

FIG. 7 depicts an example system according to example implementations of the present disclosure.

FIG. 8 depicts an example system according to example implementations of the present disclosure.

FIG. 9 depicts an example computing device to implement examples according to the present disclosure.

FIG. 10 depicts an example quantum computing device to implement examples according to the present disclosure.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Finally, it is noted that while, for purposes of illustration and simplicity, the implementations are illustrated as being implemented by computer system that comprises a single computing device that in turn comprises a single processor device, in practice the examples/implementations disclosed herein may be implemented in a computer system that comprises any number of computing devices, each of which may comprise one or more processor devices. Thus, irrespective of the implementation, the examples/implementations may be implemented on a computer system that includes one or more computing devices, wherein the one or more computing devices comprise one or more processor devices, and the one or more processor devices implement functionality disclosed herein.

Hybrid systems may use a combination of classical computing devices and quantum computing devices to execute quantum services. For instance, quantum simulators implemented using one or more classical processor devices may simulate execution of at least a portion of a quantum service by a quantum computing device. Users may use quantum simulators to learn more about execution of the quantum service and/or more about the impact on performance of quantum computing devices during execution of the quantum service. It can be desirable to build robust classical simulator tools to simulate many different operating states of a quantum computing device under varying conditions.

According to some examples, quantum computing devices and classical computing devices may be networked together (e.g., using quantum channels) to provide a quantum computing network. The classical computing devices may implement one or more quantum simulator nodes to simulate a quantum computing device. Each of the quantum computing devices and each of the quantum simulator nodes may be considered a node on the quantum computing network. In some examples, the quantum computing network may have a mesh topology.

The quantum computing network may implement a simulator and physical mesh service (SPMS) to control the quantum computing network. The SPMS may receive a request to join a new physical quantum computing device to the quantum computing network. The SPMS may attach the quantum computing device to the network by providing the relevant permissions. The SPMS may query the new quantum computing device for its operating characteristics and may create an operating profile of the quantum computing device. The SPMS may communicate (e.g., broadcast) the operating profile to the nodes on the quantum computing network so that each node on the quantum computing network may have information regarding operating capabilities of all the other nodes on the quantum computing network. In this regard, when a node receives a request to execute a quantum service (e.g., a request specifically addressed to the node), the node may choose to pass the request for execution by a node that is more suitable and/or fine-tuned to execute the quantum service associated with the request.

Upon receipt of a request to join a new physical quantum computing device to the quantum computing network, the SPMS may also generate a simulator node to be executed on a classical computing device for the quantum computing device. The simulator node may simulate an operating state of the quantum computing device. According to examples, the SPMS may generate a plurality of quantum simulator nodes for the quantum computing device. Each quantum simulator node may simulate one of a plurality of different operating states for the quantum computing device. Each operating state may be associated with a parameter set. The parameter set may include data indicative of one or more of a number of qubits, qubit type, quantum error correction scheme, qubit load, qubit noise profile, or other parameter(s) associated with operation of the quantum computing device.

Each quantum simulator node may be stored as an execution node of the quantum computing device to execute the quantum service. An execution node is a node on the quantum computing network that may execute a quantum service. An execution node may be a quantum simulator node or may be a physical quantum computing device capable of executing a quantum service.

In some implementations, the SPMS may implement a plurality of monitoring periods on the new quantum computing device. The SPMS may determine an operating state for the quantum computing device for each monitoring period and generate a quantum simulator node for the operating state for each monitoring period. When configurable thresholds are met, the SPMS may transition from one monitoring period to another monitoring period. The thresholds may be time based, performance based, resource based, or based on any other metric or criteria that is useful for transitioning monitoring periods.

Aspects of the present disclosure may have technical effects and benefits. For instance, the SPMS may generate multiple quantum simulator nodes for multiple variations of quantum computing device(s) so that a quantum computing network has access to the most appropriate simulator node for execution and/or training of a quantum service. For instance, upon receipt of a request to execute a quantum service that is designated for a specific operating state/hardware, a node in the quantum computing network may poll the other nodes on the quantum computing network (e.g., via an application programming interface (API)), obtain information regarding performance of quantum computing devices at the time of the request, and have the SPMS route the request to a quantum simulator node and/or physical quantum computing device associated with an operating state that best matches the requirements of the quantum service. In this way, the examples provided herein may provide for more intelligent routing in a quantum computing network for execution of quantum services. In addition, the quantum computing network may provide a variety of different physical quantum computing devices and different quantum simulator nodes for fine tuning the training and/or configuration of quantum services.

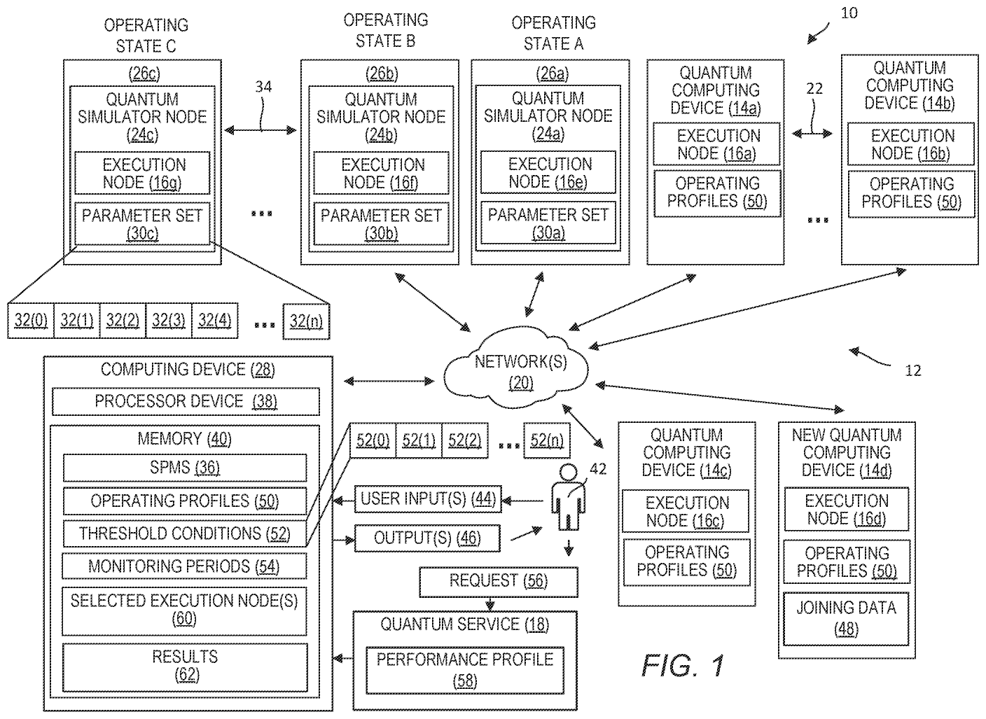

FIG. 1 is a block diagram of a system 10 in which examples may be practiced. The system 10 includes a quantum computing network 12. The quantum computing network 12 includes a plurality of interconnected quantum computing devices 14a, 14b, 14c, . . . 14d. The example of FIG. 1 illustrates four quantum computing devices 14a, 14b, 14c, 14d for purposes of illustration and discussion. The quantum computing network 12 may have more or fewer quantum computing devices without deviating from the scope of the present disclosure.

The quantum computing devices 14a, 14b, 14c, . . . 14d may use quantum bits, referred to herein as “qubits,” each of which has properties that differ from those of classical (i.e., non-quantum) bits used in classical computing. A qubit encodes quantum information for an underlying particle such as an atom or a photon and possesses characteristics that differ from those of classical (i.e., non-quantum) bits used in classical computing. For example, while a classical bit may be in a state of either one (1) or zero (0), a qubit may be in a “superposition” of both states simultaneously. A pair of qubits may also experience a physical phenomenon referred to as “entanglement,” in which the quantum state of each qubit may not be described independently of the state of the other qubit.

Each quantum computing device 14a, 14b, 14c, . . . 14d may implement an execution node 16a, 16b, 16c, . . . 16d of the quantum computing network 12. More particularly, each quantum computing device 14a, 14b, 14c, . . . 14d may execute a quantum service 18 specified, for instance, by a quantum service definition file (e.g., Quantum Assembly File (QASM File)).

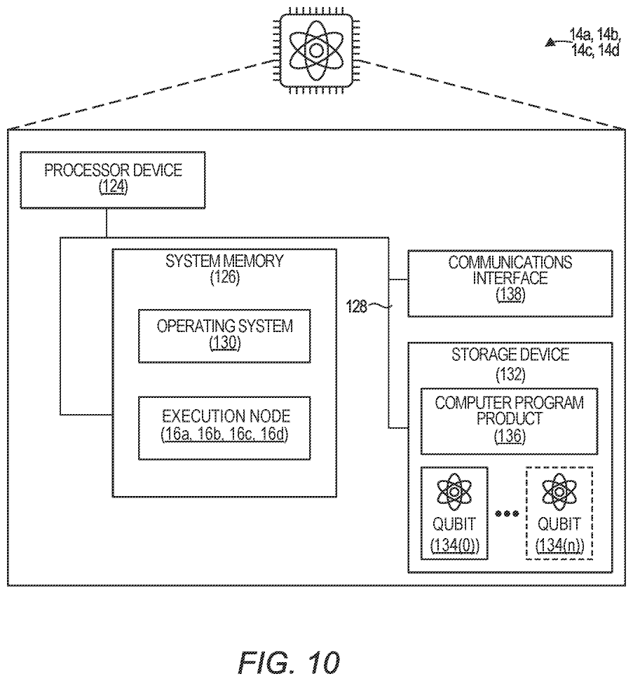

The quantum computing devices 14a, 14b, 14c, . . . 14d may employ qubits to execute quantum services to provide desired functionality. For instance, each quantum computing device 14a, 14b, 14c, . . . 14d may instantiate qubits, place them into specific quantum states and relationships, store values using the qubits, and/or subsequently deallocate and reuse the qubits to return a result for the quantum service. In examples, each quantum computing device 14a, 14b, 14c, . . . 14d may operate using classical computing principles or quantum computing principles. When using quantum computing principles, the quantum computing devices 14a, 14b, 14c, . . . 14d perform computations that utilize quantum-mechanical phenomena, such as superposition and entanglement. The quantum computing devices 14a, 14b, 14c, . . . 14d may operate under certain environmental conditions, such as at or near 0° Kelvin. When using classical computing principles, the quantum computing devices 14a, 14b, 14c, . . . 14d may utilize binary digits that have a value of either 1 or 0. Details concerning example quantum computing devices 14a, 14b, 14c, . . . 14d will be set forth with reference to FIG. 10.

Referring to FIG. 1, the quantum computing devices 14a, 14b, 14c, . . . 14d may be connected to one another and may communicate with one another using a network 20. The network 20 may include one or more communication links (e.g., wired and/or wireless communication links). In some implementations, the quantum computing devices 14a, 14b, 14c, . . . 14d may be in a mesh topology. For instance, each quantum computing device 14a, 14b, 14c, . . . 14d may be connected to each other quantum computing device 14a, 14b, 14c, . . . 14d either through a direct communication link, such as example direct communication link 22 between quantum computing device 14a and 14b, or through one or more intermediary quantum computing devices or other nodes on the network 20.

The quantum computing network 12 may further include a plurality of quantum simulator nodes 24a, 24b, . . . 24c. Each quantum simulator node 24a, 24b, . . . 24c may provide a classical simulation (e.g., using a classical computing device 26a, 26b, . . . 26c) of execution of the quantum service 18 by a quantum computing device, such as quantum computing device 14a, 14b, 14c, . . . 14d. For instance, each quantum simulator node 24a, 24b, . . . 24c may be implemented, for instance, by a classical processor device executing computer-readable instructions stored in a memory coupled to the processor device. In this way, each quantum simulator node 24a, 24b . . . 24c may act as an execution node 16e, 16f, . . . 16g of the quantum computing network 12 and may return results of execution of a quantum service 18.

In the example of FIG. 1, each quantum simulator node 24a, 24b, . . . 24c may be implemented on a separate classical computing device 26a, 26b, . . . 26c. Those of ordinary skill in the art, using the disclosure provided herein, will understand that the quantum simulator nodes 24a, 24b, . . . 24c may be implemented on the same classical computing device and/or any suitable number or combination of classical computing devices without deviating from the scope of the present disclosure, including on a computing device 28.

In examples, each quantum simulator node 24a, 24b, . . . 24c may be associated with a different operating state of a quantum computing device, such as quantum computing device 14a, 14b, 14c, . . . 14d. For instance, each quantum simulator node 24a, 24b, . . . 24c may simulate a different operating state for a single quantum computing device, such as quantum computing device 14d. In particular, the quantum simulator node 24a may simulate quantum computing device 14d operating in operating state A. The quantum simulator node 24b may simulate quantum computing device 14d operating in operating state B. The quantum simulator node 24c may simulate quantum computing device 14d operating in operating state C.

Each operating state of a quantum computing device, such as quantum computing device 14a, 14b, 14c, . . . 14d, may be associated with a parameter set 30a, 30b, . . . 30c. For instance, operating state A may be associated with parameter set 30a. Operating state B may be associated with parameter set 30b. Operating state C may be associated with parameter set 30c.

Each parameter set 30a, 30b, . . . 30c may define characteristics associated with its corresponding operating state of a quantum computing device, such as quantum computing device 14a, 14b, 14c, . . . 14d. The parameter sets 30a, 30b, and 30c may include, for instance, data 32(0)-32(n). The data 32(0)-32(n) may include, for instance, data indicative of number of qubits 32(0), data indicative of qubit type 32(1), data indicative of quantum error correction scheme 32(2), data indicative of qubit load 32(3), data indicative of qubit noise profile 32(4), and/or other data 32(n) indicative of configuration or operation of a quantum computing device.

Each quantum simulator node 24a, 24b, . . . 24c may be connected to one another and to the quantum computing devices 14a, 14b, 14c, . . . 14d using the network 20. In some implementations, the quantum simulator nodes 24a, 24b, . . . 24c and the quantum computing devices 14a, 14b, 14c, . . . 14d may be in a mesh topology. For instance, each quantum simulator node 24a, 24b, . . . 24c and each quantum computing device 14a, 14b, 14c, . . . 14d may be connected to each other either through a direct communication link, such as example direct communication link 34 between the quantum simulator node 24b and the quantum simulator node 24c, or through one or more intermediary quantum computing devices, quantum simulator nodes, or other nodes on the network 20.

The quantum computing network 12 may include a simulator and physical mesh service (SPMS) 36. The SPMS 36 may implement functionality disclosed herein to add quantum computing devices to the quantum computing network 12, create quantum simulator nodes 24a, 24b, . . . 24c to simulate varying operating states of one or more quantum computing devices on the network, and facilitate routing of a quantum service 18 to appropriate execution nodes 16a, 16b, 16c, 16d, 16e, 16f, . . . 16g for execution.

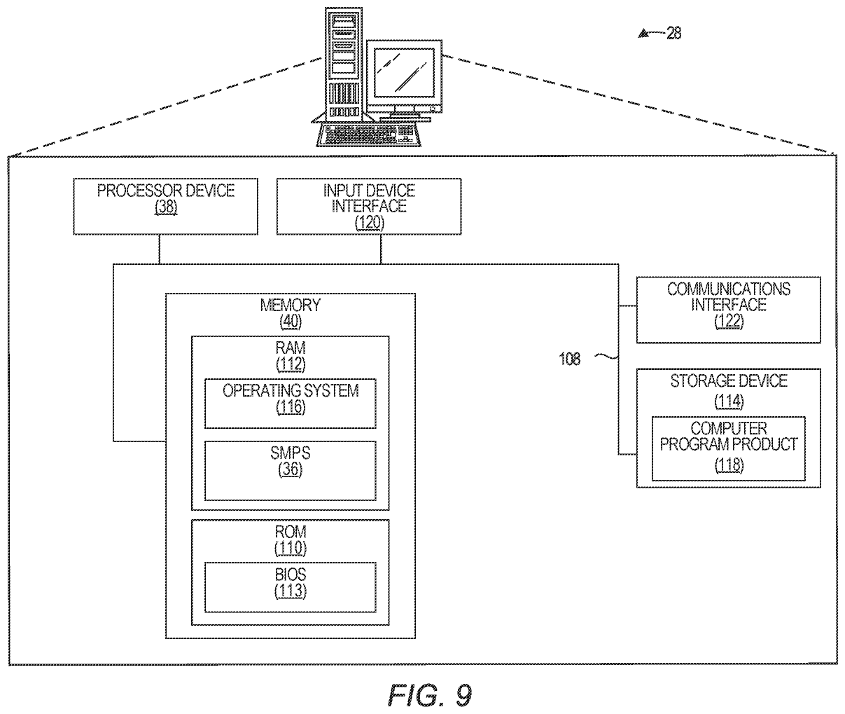

The SPMS 36 may be implemented by the computing device 28 connected to the network 20. The computing device 28 may include a processor device 38. The processor device 38 may be operatively coupled to a memory 40. A user 42 may interact with the SPMS 36 and/or the quantum computing network 12 by providing a user input(s) 44 to the computing device 28 and/or receiving output(s) 46 from the computing device 28 via a suitable user interface (e.g., a graphical user interface presented on a display device). Details concerning an example computing device 28 are discussed with reference to FIG. 9.

Referring to FIG. 1, because the SPMS 36 is a component of the computing device 28, functionality implemented by the SPMS 36 may be attributed to the computing device 28 generally. Moreover, in examples where the SPMS 36 comprises software instructions that program the processor device 38 to carry out functionality discussed herein; functionality implemented by the SPMS 36 may be attributed herein to the processor device 38.

It is further noted that while the SPMS 36 is shown as a single component, in other implementations, the SPMS 36 may be implemented in a plurality of components. Finally, it is noted that while, for purposes of illustration and simplicity, the examples are illustrated as being implemented by a single processor device on a single computing device, in other environments, such as a distributed and/or clustered environment, and where the SPMS 36 is implemented in multiple components, the SPMS 36 may be implemented on a computer system that includes a plurality of processor devices of a plurality of different computing devices. Thus, irrespective of the implementation, the examples may be implemented on a computer system that includes one or more processor devices of one or more computing devices.

In some examples, a new quantum computing device 14d may join the quantum computing network 12. The SPMS 36 may receive joining data 48 from the new quantum computing device 14d (e.g., data indicative of the quantum computing device 14d joining the quantum computing network 12). The SPMS 36 may join the new quantum computing device 14d to the quantum computing network 12 by providing relevant permissions to the new quantum computing device 14d.

The SPMS 36 may query the new quantum computing device 14d for its operating profile 50. The operating profile 50 may provide characteristics of the new quantum computing device 14d, such as identifying data, number of qubits, type of qubits, resource availability, and other characteristics. The SPMS 36 may receive the operating profile 50 from the new quantum computing device 14d. The SPMS 36 may communicate the operating profile 50 of the new quantum computing device 14d to all other nodes on the quantum computing network 12. In this way, each node on the quantum computing network 12 may have data indicative of operating profiles 50 of all other nodes on the quantum computing network 12.

For instance, as illustrated in FIG. 1, each of the quantum computing devices 14a, 14b, 14c, . . . 14d may have data indicative of operating profiles 50 of all other nodes on the quantum computing network 12, including all other quantum computing devices 14a, 14b, 14c, . . . 14d and all other quantum simulator nodes 24a, 24b, . . . 24c. Similarly, although not illustrated in FIG. 1, each of the quantum simulator nodes 24a, 24b, . . . 24c may have data indicative of operating profiles 50 of all other nodes on the quantum computing network 12, including all other quantum computing devices 14a, 14b, 14c, . . . 14d and all other quantum simulator nodes 24a, 24b, . . . 24c. The computing device 28 implementing the SPMS 36 may also have data indicative of operating profiles 50 of all other nodes on the quantum computing network 12, including all quantum computing devices 14a, 14b, 14c, . . . 14d and all quantum simulator nodes 24a, 24b, . . . 24c.

In this way, each node in the quantum computing network 12 may have data indicative of operating profiles 50 for all other nodes in the quantum computing network 12. In that regard, if a specific node in the quantum computing network 12 receives a request to execute a quantum service 18 (e.g., a request specifically addressed to the node), the node may access the data indicative of operating profiles 50 for all other nodes on the quantum computing network 12 and route the quantum service 18 to the most suitable node on the quantum computing network 12 for execution.

According to some examples, the SPMS 36 may also generate the plurality of quantum simulator nodes 24a, 24b, 24c . . . for different operating states of the new quantum computing device 14d. Upon receipt of the joining data 48, the SPMS 36 may generate the quantum simulator nodes 24a, 24b, . . . 24c associated with different operating states of the new quantum computing device 14d. More particularly, the SPMS 36 my generate instructions for each quantum simulator node 24a, 24b, . . . 24c that when executed by one or more classical processor devices simulate execution of a quantum service 18 by the quantum computing device 14d in different operating states.

As an example, the SPMS 36 my generate instructions for quantum simulator node 24a to simulate operating state A of the new quantum computing device 14d. Operating state A may be associated with parameter set 30a. The SPMS 36 may generate instructions for quantum simulator node 24b to simulate operating state B of the new quantum computing device 14d. Operating state B may be associated with parameter set 30b. The SPMS 36 may generate instructions for quantum simulator node 24c to simulate operating state C of the new quantum computing device 14d. Operating state C may be associated with parameter set 30c.

The SPMS 36 may use threshold conditions 52 to establish monitoring periods 54 for the generation of the quantum simulator nodes 24a, 24b, . . . 24c for the new quantum computing device 14d. For instance, the SPMS 36 may determine an operating state for each monitoring period 54 and generate a quantum simulator node 24a, 24b, . . . 24c corresponding to each monitoring period 54.

The threshold conditions 52 may be based on different factors. In some examples, the threshold conditions 52 may be time-based threshold conditions 52(0). For instance, a monitoring period may be defined based on the occurrence of the expiration of a threshold time period. In some examples, the threshold conditions 52 may be performance-based threshold conditions 52(1). For instance, performance thresholds for the quantum computing device 14d may determine the transition of monitoring periods 54 for establishment of quantum simulator nodes 24a, 24b, . . . 24c. In some examples, the threshold conditions 52 may be resource-based threshold conditions 52(2). For instance, resource thresholds (e.g., qubit resource thresholds) for the quantum computing device 14d may determine the transition of monitoring periods 54 for establishment of quantum simulator nodes 24a, 24b, . . . 24c.

Once the SPMS 36 has generated the quantum simulator nodes 24a, 24b, . . . 24c, the SPMS 36 may store the quantum simulator nodes 24a, 24b, . . . 24c as execution nodes 16e, 16f, . . . 16g on the quantum computing network 12. For instance, the SPMS 36 may identify to the quantum computing network 12 and to nodes on the quantum computing network 12 that the quantum simulator nodes 24a, 24b, . . . 24c are available as execution nodes 16e, 16f, . . . 16g for execution of a quantum service 18. In this way, the SPMS 36 may establish quantum simulator nodes 24a, 24b, . . . 24c for multiple variations of operating states of the same physical quantum computing device 14d to provide a more robust network of execution nodes 16a, 16b, 16c, 16d, 16e, 16f, . . . 16g for execution of a quantum service 18.

As an example, a user 42 may provide a request 56 to computing device 28 for the quantum computing network 12 to execute quantum service 18. The quantum service 18 may have an associated performance profile 58. The performance profile 58 may include data, annotations and/or instructions specifying operating characteristics of a quantum computing device intended for execution of the quantum service 18.

In some examples, the SPMS 36 may determine the performance profile 58 by analyzing a quantum service definition file (e.g., QASM file) associated with the quantum service 18. For instance, the SPMS 36 may identify one or more instruction sets within the quantum service definition file. Based on the instruction sets, the SPMS 36 may determine which quantum computing device 14a, 14b, 14c, . . . 14d and/or operating state of a quantum computing device 14a, 14b, 14c, . . . 14d may provide for efficient and/or fine-tuned execution of the quantum service 18. In some examples, the SPMS 36 may determine the performance profile 58 based on information specified by a user 42 (e.g., as part of a request 56 to execute the quantum service 18)

The SPMS 36 may determine a selected execution node 60 of the plurality of execution nodes 16a, 16b, 16c, 16d, 16e, 16f, . . . 16g for execution of the quantum service 18 based on the performance profile 58 for the quantum service 18. The SPMS 36 may route the quantum service 18 to the selected execution node 60 for execution of the quantum service 18. The SPMS 36 may obtain results 62 of execution of the quantum service 18 from the selected execution node 60 and store them in memory 40. The SPMS 36 may provide the results 62 to the user as an output 46 of the computing device 28 (e.g., via a graphical user interface).

Aspects are discussed with reference to a user interacting with SPMS 36 via the computing device 28 for purposes of illustration and discussion. Those of ordinary skill in the art, using the disclosures provided herein, will understand that a user 42 may interact with any node on the quantum computing network 12, such as quantum computing devices 14a, 14b, 14c, . . . 14d, classical computing devices 26a, 26b, . . . 26c, or other node on the quantum computing network 12 without deviating from the scope of the present disclosure.

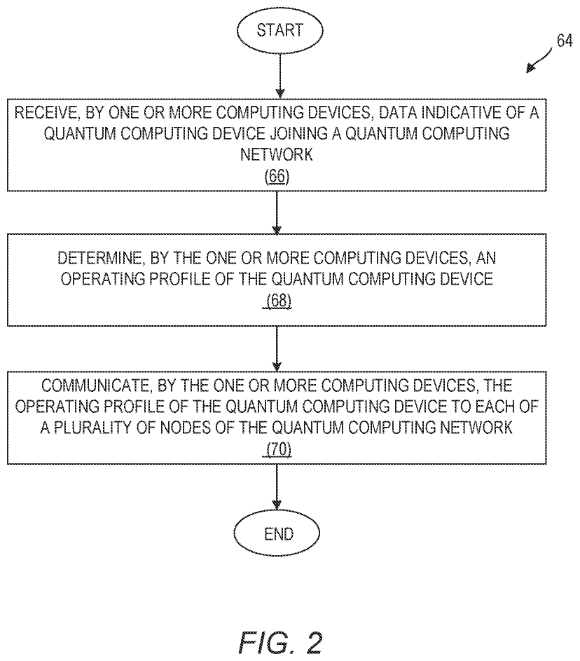

FIG. 2 is a flowchart 64 of an example method according to example implementations of the present disclosure. FIG. 2 may be implemented using one or more computing devices, such as computing device 28 of FIG. 1. Elements of FIG. 1 are referenced in describing FIG. 2 for the sake of clarity. It is to be understood that, in some examples, some operations illustrated in FIG. 2 may be performed in an order other than illustrated herein, include operations not illustrated, and/or may be omitted.

In FIG. 2, the computing device 28 (e.g., the SPMS 36) may obtain a joining data 48 indicative of a quantum computing device 14d joining the quantum computing network 12 (Block 66). For instance, in some implementations, the computing device 28 may receive a notification of a request to join a new quantum computing device 14d to join the quantum computing network 12. In some implementations, the computing device 28 may receive data indicating a new quantum computing device 14d is made available on the quantum computing network 12. The data may include identifying information and other information associated with the quantum computing device 14d.

The computing device 28 (e.g., the SPMS 36) may determine an operating profile 50 of the quantum computing device 14d (Block 68). In some implementations, the computing device may query the quantum computing device 14d for its operating profile 50. The operating profile 50 may provide characteristics of the new quantum computing device 14d, such as identifying data, number of qubits, type of qubits, resource availability, and other characteristics. The computing device 28 may receive data indicative of the operating profile 50 from the quantum computing device 14d in response to the query.

The computing device 28 (e.g., the SPMS 36) may communicate the operating profile of the quantum computing device 14d to each of a plurality of nodes (e.g., quantum computing devices 14a, 14b, . . . 14c and quantum simulator nodes 24a, 24b, . . . 24c) on the quantum computing network 12 (Block 70). In this way, each node on the quantum computing network 12 may have data indicative of operating profiles 50 of all other nodes on the quantum computing network 12. Each node may use the operating profiles 50 to route a quantum service 18 to a most appropriate node on the quantum computing network 12 to pass the quantum service 18 to the most efficient and/or fine-tuned execution node 16a, 16b, 16c, 16d, 16e, 16f, . . . 16g on the quantum computing network 12 for execution.

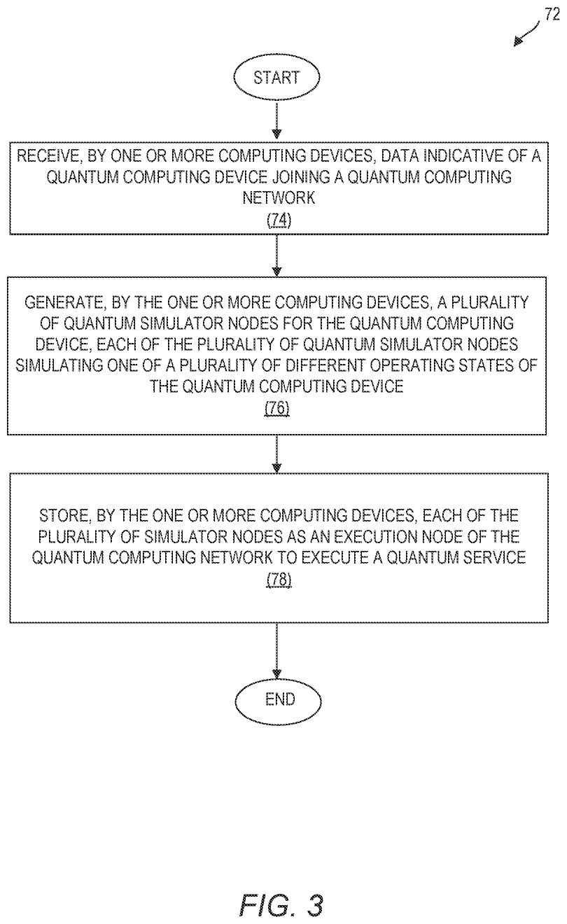

FIG. 3 is a flow chart 72 of an example method according to example implementations of the present disclosure. FIG. 3 may be implemented using one or more computing devices, such as computing device 28 of FIG. 1. Elements of FIG. 1 are referenced in describing FIG. 3 for the sake of clarity. It is to be understood that, in some examples, some operations illustrated in FIG. 3 may be performed in an order other than illustrated herein, include operations not illustrated, and/or may be omitted.

In FIG. 3, the computing device 28 (e.g., the SPMS 36) may obtain a joining data 48 indicative of a quantum computing device 14d joining the quantum computing network 12 (Block 74). For instance, in some implementations, the computing device 28 may receive a notification of a request to join a new quantum computing device 14d to join the quantum computing network 12. In some implementations, the computing device 28 may receive data indicating a new quantum computing device 14d is made available on the quantum computing network 12. The data may include identifying information and other information associated with the quantum computing device 14d.

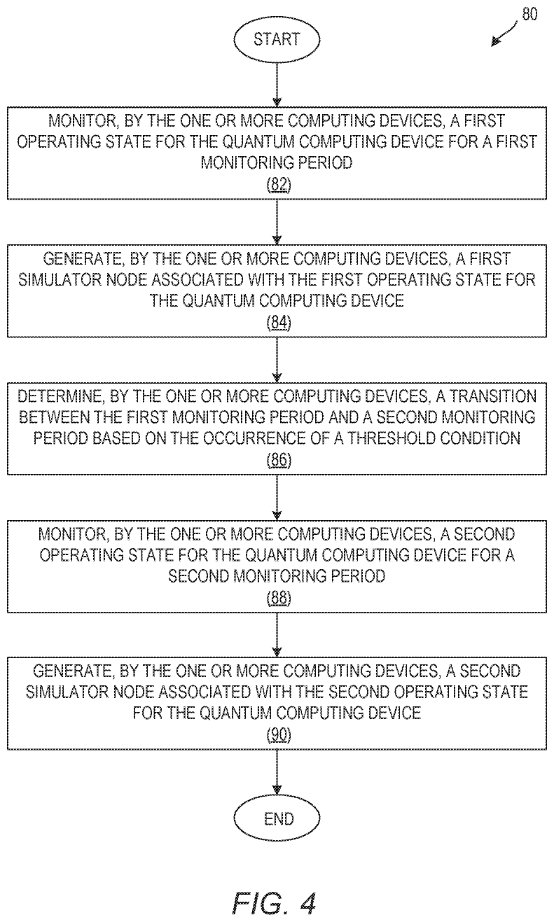

The computing device 28 (e.g., the SPMS 36) may generate a plurality of quantum simulator nodes 24a, 24b, . . . 24c for the quantum computing device 14d. Each of the quantum simulator nodes 24a, 24b, . . . 24d may simulate one of a plurality of different operating states of the quantum computing device 14d (Block 76). In some examples, the computing device 28 (e.g., the SPMS 36) may generate the quantum simulator nodes 24a, 24b, . . . 24c by generating instructions that model the operating state of the quantum computing device 14d during different monitoring periods as discussed with reference to FIG. 4.

Each of the quantum simulator nodes 24a, 24b, . . . 24c may be associated with a parameter set 30a, 30b, . . . 30c. Each parameter set 30a, 30b, . . . 30c may define characteristics associated with a different operating state of quantum computing device 14d. The parameter sets 30a, 30b, and 30c may include, for instance, data 32(0)-32(n). The data 32(0)-32(n) may include, for instance, data indicative of number of qubits 32(0), data indicative of qubit type 32(1), data indicative of quantum error correction scheme 32(2), data indicative of qubit load 32(3), data indicative of qubit noise profile 32(4), and/or other data 32(n) indicative of configuration or operation of the quantum computing device 14d.

In FIG. 3, the computing device 28 (e.g., the SPMS 36) may store each of the plurality of quantum simulator nodes 24a, 24b, . . . 24c as an execution node 16e, 16f, . . . 16g on the quantum computing network 12 for execution of a quantum service 18 (Block 78). For instance, the SPMS 36 may identify to the quantum computing network 12 and to nodes on the quantum computing network 12 that the quantum simulator nodes 24a, 24b, . . . 24c are available as execution nodes 16e, 16f, . . . 16g for execution of a quantum service 18.

FIG. 4 is a flow chart 80 of an example method for generating a plurality of quantum simulator nodes according to examples of the disclosure. FIG. 4 may be implemented, for instance, by one or more computing devices, such as the computing device 28 (e.g., the SPMS 36). Elements of FIG. 1 are referenced in describing FIG. 4 for the sake of clarity. It is to be understood that, in some examples, some operations illustrated in FIG. 4 may be performed in an order other than illustrated herein, include operations not illustrated, and/or may be omitted.

In FIG. 4, the computing device 28 (e.g., the SPMS 36) may monitor a first operating state for the quantum computing device 14d for a first monitoring period (Block 82). The computing device 28 (e.g., the SPMS 36) may generate a first simulator node (e.g., quantum simulator node 24a) based at least in part on the first operating state (e.g., operating state A) for the quantum computing device 14d (Block 84). The first operating state may be associated with a parameter set 30a.

In FIG. 4, the computing device 28 (e.g., the SPMS 36) may determine a transition between the first monitoring period and a second monitoring period based on the occurrence of a threshold condition 52 (Block 86). The threshold condition 52 may be based on different factors. In some examples, the threshold condition 52 may be one or more time-based threshold conditions 52(0). For instance, a threshold condition 52 may occur at the expiration of a period of time. In some examples, the threshold condition 52 may be one or more performance-based threshold conditions 52(1). For instance, a threshold condition 52 may occur when the quantum computing device 14d meets some threshold performance metric. In some examples, the threshold condition 52 may be one or more resource-based threshold conditions 52(2). For instance, a threshold condition 52 may occur when the quantum computing device 14d uses some threshold computing resources (e.g., qubit resources).

In FIG. 4, the computing device 28 (e.g., the SPMS 36) may monitor a second operating state for the quantum computing device 14d for a second monitoring period (Block 88). The computing device 28 (e.g., the SPMS 36) may generate a second simulator node (e.g., quantum simulator node 24b) based at least in part on the second operating state (e.g., operating state A) for the quantum computing device 14d (Block 90). The second operating state may be associated with a parameter set 30b.

FIG. 4 depicts a flow chart associated with first and second monitoring periods and first and second quantum simulator nodes for purposes of illustration and discussion. The computing device 28 (e.g., the SPMS 36) may continue to monitor a third operating state for a third monitoring period and generate a third quantum simulator node (e.g., quantum simulator node 24c); to monitor a fourth operating state for a fourth monitoring period and generate a fourth quantum simulator node, and so forth, upon determination of transitions between monitoring periods 54 based on the occurrence of a threshold condition 52.

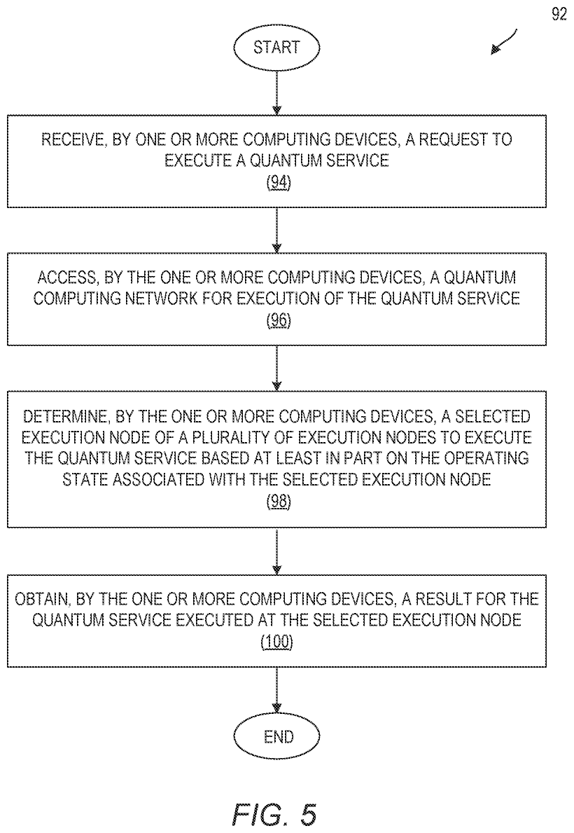

FIG. 5 is a flow chart 92 of an example method according to examples of the disclosure. FIG. 5 may be implemented, for instance, by one or more computing devices, such as the computing device 28 (e.g., the SPMS 36) or any of the nodes on the quantum computing network 12. Elements of FIG. 1 are referenced in describing FIG. 5 for the sake of clarity. It is to be understood that, in some examples, some operations illustrated in FIG. 5 may be performed in an order other than illustrated herein, include operations not illustrated, and/or may be omitted.

In FIG. 5, the computing device 28 (e.g., the SPMS 36) may receive a request to execute a quantum service 18 (Block 94). The computing device 28 (e.g., the SPMS 36) may access the quantum computing network 12 for execution of the quantum service 18 (Block 96). The computing device 28 (e.g., the SPMS 36) may determine a selected execution node 60 of a plurality of execution nodes 16a, 16b, 16c, 16d, 16e, 16f, . . . 16g, to execute the quantum service 18 based at least in part on an operating state (e.g., operating state A, operating state B, operating state C) associated with the selected execution node 60 (Block 98). The quantum service 18 may be executed at the selected execution node 60 to determine one or more results 62 for the quantum service 18. The computing device 28 (e.g., the SPMS 36) may obtain the result 62 for the quantum service 18 executed at the selected execution node 60 (Block 100).

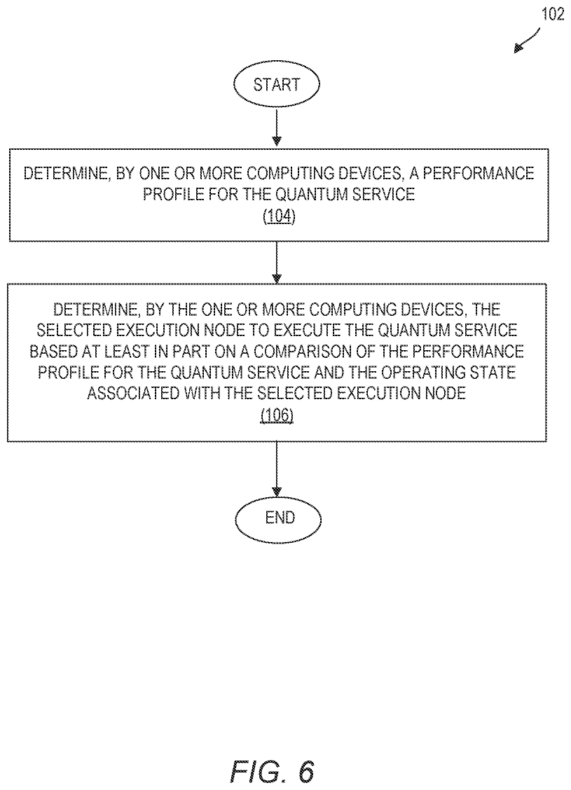

FIG. 6 is a flow chart 102 of an example method for determining a selected execution node 60 according to examples of the disclosure. FIG. 6 may be implemented, for instance, by one or more computing devices, such as the computing device 28 (e.g., the SPMS 36) or any of the nodes on the quantum computing network 12. Elements of FIG. 1 are referenced in describing FIG. 6 for the sake of clarity. It is to be understood that, in some examples, some operations illustrated in FIG. 6 may be performed in an order other than illustrated herein, include operations not illustrated, and/or may be omitted.

In FIG. 6, the computing device 28 (e.g., the SPMS 36) may determine a performance profile for the quantum service 18 (Block 104). For instance, the quantum service 18 may have an associated performance profile 58. The performance profile 58 may include data, metadata, annotations and/or instructions specifying operating characteristics of a quantum computing device suitable for execution of the quantum service 18. The computing device 28 (e.g., the SPMS 36) may be able to determine the performance profile 58 based on the data, metadata, annotations and/or instructions. In some examples, the computing device 28 (e.g., the SPMS 36) may determine the performance profile 58 by analyzing a quantum service definition file (e.g., QASM file) associated with the quantum service 18. For instance, the computing device 28 (e.g., the SPMS 36) may identify one or more instruction sets within the quantum service definition file and determine the performance profile 58. In some examples, the computing device 28 (e.g., the SPMS 36) may determine the performance profile 58 based on information specified by a user 42 (e.g., as part of a request 56 to execute the quantum service 18)

In FIG. 6, the computing device 28 (e.g., the SPMS 36) may determine the selected execution node 60 to execute the quantum service 18 based at least in part on a comparison of the performance profile 58 for the quantum service 18 and the operating state of the selected execution node 60. For instance, the computing device 28 (e.g., the SPMS 36) may determine which execution node 16a, 16b, 16c, 16d, 16e, 16f, . . . 16g, corresponds to an operating state that matches or closely matches the operating profile 58 of the quantum service 18. This execution node 16a, 16b, 16c, 16d, 16e, 16f, . . . 16g may be determined as the selected execution node 60.

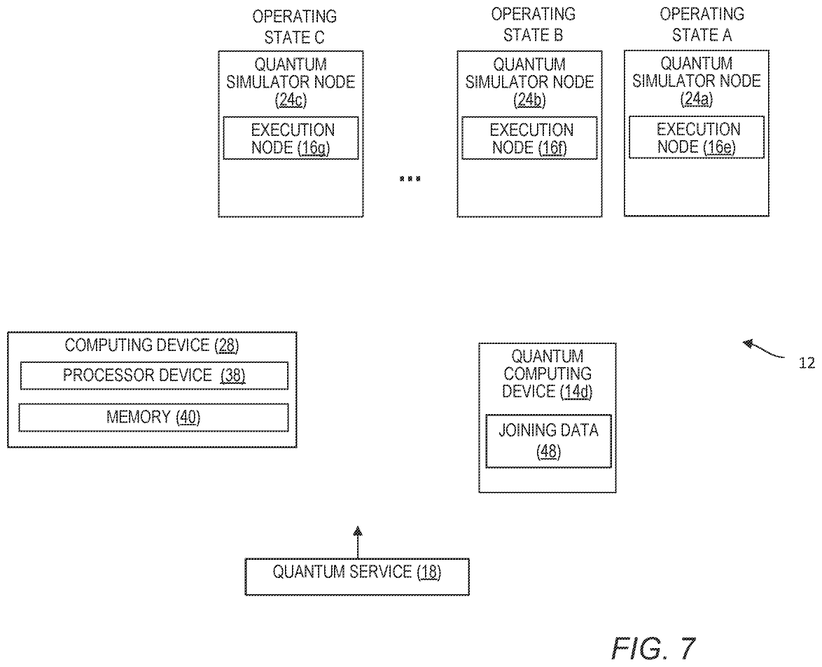

FIG. 7 depicts a simplified diagram of a computing device 28 according to example implementations of the present disclosure. The computing device 28 includes a memory 40. The computing device 28 includes a processor device 38. The processor device 38 is communicatively coupled to the memory 40 to receive data 48 indicative of a quantum computing device 14d joining a quantum computing network 12. The processor device 38 is communicatively coupled to the memory 40 to generate a plurality of quantum simulator nodes 24a, 24b, . . . 24c for the quantum computing device 14d. Each of the plurality of quantum simulator nodes 24a, 24b, . . . 24c is to simulate a different operating state (e.g., operating state A, operating state B, operating state C) of the quantum computing device 14d. The processor device 38 is communicatively coupled to the memory 40 to store each of the plurality of quantum simulator nodes 24a, 24b, . . . 24c as an execution node 16e, 16f, . . . 16g of the quantum computing network 12 to execute a quantum service 18.

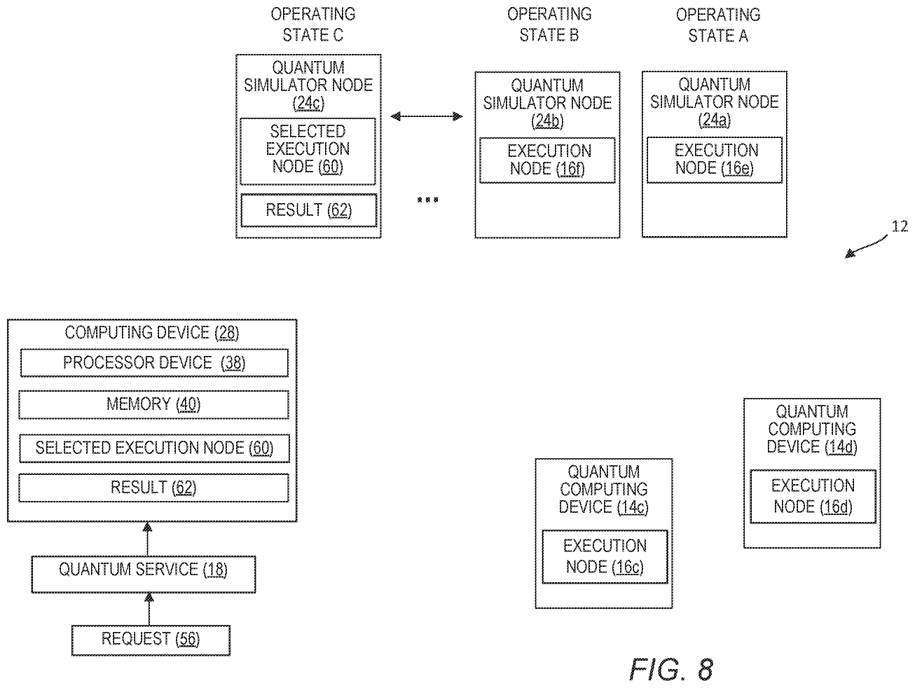

FIG. 8 depicts a simplified diagram of a computing device 28 according to example implementations of the present disclosure. The computing device 28 includes a memory 40. The computing device 28 includes a processor device 38. The processor device 38 is communicatively coupled to the memory 40 to receive a request 56 to execute a quantum service 18. The processor device 38 is communicatively coupled to the memory 40 to access a quantum computing network 12 to execute the quantum service 18. The quantum computing network 12 includes a plurality of quantum computing devices 14c, . . . 14d and a plurality of quantum simulator nodes 24a, 24b, . . . 24c. Each quantum simulator node 24a, 24b, . . . 24c is to simulate a different operating state (e.g., operating state A, operating state B, operating state C) for one of the plurality of quantum computing devices 14d. The plurality of quantum computing devices 14c, . . . 14d, and the plurality of quantum simulator nodes 24a, 24b, . . . 24c are each an execution node 16c, 16d, 16,16e, . . . 16f of the quantum computing network 12. The processor device 38 is communicatively coupled to the memory 40 to determine a selected execution node 60 to execute the quantum service 18 based at least in part on an operating state (e.g., operating state C) associated with the selected execution node 60. The processor device 38 is communicatively coupled to the memory 40 to obtain a result 62 for the quantum service 18 at the selected execution node 60.

FIG. 9 is a block diagram of the computing device 28 suitable for implementing examples. FIG. 9 is representative of computing device 28 for purposes of illustration. FIG. 9 may also be representative of other computing devices, such as computing devices 26a, 26b, . . . 26c of FIG. 1. The computing device 28 may comprise any computing or electronic device capable of including firmware, hardware, and/or executing software instructions to implement the functionality described herein, such as a computer server, a desktop computing device, a laptop computing device, or the like. The computing device 28 includes the processor device 38, the memory 40, and a system bus 108. The system bus 108 provides an interface for system components including, but not limited to, the memory 40 and the processor device 38. The processor device 38 may be any commercially available or proprietary processor.

The memory 40 may include non-volatile memory 110 (e.g., read-only memory (ROM), erasable programmable read-only memory (EPROM), electrically erasable programmable read-only memory (EEPROM), etc.), and volatile memory 112 (e.g., random-access memory (RAM)). A basic input/output system (BIOS) 113 may be stored in the non-volatile memory 110 and may include the basic routines that help to transfer information between elements within the computing device 28. The volatile memory 1112 may also include a high-speed RAM, such as static RAM, for caching data.

The computing device 28 may further include or be coupled to a non-transitory computer-readable storage medium such as the storage device 114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules may be stored in the storage device 114 and in the volatile memory 112, including an operating system 116 and one or more program modules, such as the SPMS 36, which may implement the functionality described herein in whole or in part.

All or a portion of the examples may be implemented as a computer program product 118 stored on a transitory or non-transitory computer-usable or computer-readable storage medium, such as the storage device 114, which includes complex programming instructions, such as complex computer-readable program code, to cause the processor device 38 to carry out the steps described herein. Thus, the computer-readable program code may comprise software instructions for implementing the functionality of the examples described herein when executed on the processor device 38. The processor device 38, in conjunction with the SPMS 36 in the volatile memory 112, may serve as a controller, or control system, for the computing device 28 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 38 through an input device interface 120 that is coupled to the system bus 108 but may be connected by other interfaces such as a parallel port, an Institute of Electrical and Electronic Engineers (IEEE) 1394 serial port, a Universal Serial Bus (USB) port, an IR interface, and the like.

The computing device 28 may also include a communications interface 122 suitable for communicating with the network 20 (FIG. 1) or other devices as appropriate or desired.

FIG. 10 is a block diagram of a quantum computing device 14a, 14b, 14c, . . . 14d suitable for implementing examples according to example implementations. The quantum computing device 14a, 14b, 14c, . . . 14d may comprise any computing or electronic device capable of including firmware, hardware, and/or executing software instructions to implement the functionality described herein in a quantum environment. The quantum computing device 14d includes one or more processor device(s) 124, one or more memory device(s) 126 and a system bus 128. The system bus 128 provides an interface for system components including, but not limited to, the one or more memory device(s) 126 and the one or more processor device(s) 124. The one or more processor device(s) 124 may be any commercially available or proprietary processor suitable for operating in a quantum environment. The one or more memory device(s) 126 may store computer-readable instructions associated with an operating system 130 and/or an execution node 16a, 16b, 16c, 16d.

The quantum computing device 14a, 14b, 14c, . . . 14d may further include or be coupled to a non-transitory computer-readable storage medium such as a storage device 132. The storage device 132 and other drives associated with computer-readable media and computer-usable media may provide non-volatile storage of data, data structures, computer-executable instructions, and the like. The storage device 132 may also store one or more qubits 134(0)-134(n), which may be measured and/or manipulated by the one or more processor device(s) 124 when performing quantum computing operations.

All or a portion of the examples may be implemented as a computer program product 136 stored on a transitory or non-transitory computer-usable or computer-readable storage medium, such as the storage device 132, which includes complex programming instructions, such as complex computer-readable program code, to cause the one or more processor devices 124 to carry out the functionality described herein. Thus, the computer-readable program code may comprise software instructions for implementing the functionality of the examples described herein when executed on the one or more processor devices 124.

An operator may also be able to enter one or more configuration commands through a keyboard (not illustrated), a pointing device such as a mouse (not illustrated), or a touch-sensitive surface (not illustrated). The quantum computing device 14a, 14b, 14c, . . . 14d may also include a communications interface 138 suitable for communicating with other computing devices, including, in some implementations, classical computing devices and/or quantum computing devices.

The examples also facilitate an improvement to computer functionality itself by providing a federated messaging mechanism to intelligently route quantum information transmitted over a communications network among quantum computing devices, resulting in improved functionality of computing devices on the communications network. Thus, the examples are directed to specific improvements in computer functionality.

What is claimed is:

1. A method, comprising:
receiving, by one or more computing devices, data indicative of a quantum computing device joining a quantum computing network;
generating, by the one or more computing devices, a plurality of quantum simulator nodes for the quantum computing device, each of the plurality of quantum simulator nodes to simulate one of a plurality of different operating states of the quantum computing device; and
storing, by the one or more computing devices, each of the plurality of quantum simulator nodes as an execution node of the quantum computing network to execute a quantum service.

2. The method of claim 1, wherein each of the plurality of different operating states is associated with a parameter set for the quantum computing device.

3. The method of claim 2, wherein the parameter set comprises data indicative of one or more of a number of qubits, qubit type, quantum error correction scheme, qubit load, or qubit noise profile.

4. The method of claim 1, wherein generating, by the one or more computing devices, a plurality of quantum simulator nodes for the quantum computing device comprises:
monitoring, by the one or more computing device, a first operating state for the quantum computing device for a first monitoring period;
generating, by the one or more computing devices, a first simulator node associated with the first operating state for the quantum computing device;
monitoring, by the one or more computing devices, a second operating state for the quantum computing device for a second monitoring period; and
generating, by the one or more computing devices, a second simulator node associated with the second operating state for the quantum computing device.

5. The method of claim 4, wherein the method comprises determining, by the one or more computing devices, a transition between the first monitoring period and the second monitoring period based at least in part on an occurrence of a threshold condition.

6. The method of claim 5, wherein the threshold condition is based at least in part on time, performance of the quantum computing device, or resources of the quantum computing device.

7. The method of claim 1, wherein the method further comprises:
determining, by the one or more computing devices, an operating profile of the quantum computing device joining the quantum computing network; and
communicating, by the one or more computing devices, the operating profile of the quantum computing device to each of a plurality of nodes of the quantum computing network.

8. The method of claim 1, wherein the quantum computing network comprises a plurality of quantum computing devices.

9. The method of claim 8, wherein each of the plurality of quantum computing devices and each of the plurality of quantum simulator nodes are an execution node of the quantum computing network to execute the quantum service.

10. The method of claim 1, wherein each quantum simulator node is implemented on one or more classical computing devices.

11. The method of claim 1, wherein the method comprises:
receiving, by the one or more computing devices, a request to execute a quantum service;
accessing, by the one or more computing devices, the quantum computing network to execute the quantum service;
determining, by the one or more computing devices, a selected execution node to execute the quantum service based at least in part on an operating state associated with the selected execution node; and
obtaining, by the one or more computing devices, a result for the quantum service executed at the selected execution node.

12. The method of claim 11, wherein determining, by the one or more computing devices, a selected execution node to execute the quantum service based at least in part on an operating state associated with the selected execution node, comprises:
determining, by the one or more computing devices, a performance profile for the quantum service; and
determining the selected execution node to execute the quantum service based at least in part by a comparison of the performance profile for the quantum service and the operating state associated with the selected execution node.

13. A computing device comprising:
a memory; and
a processor device coupled to the memory to:
receive a request to execute a quantum service;
access a quantum computing network to execute the quantum service, the quantum computing network comprising a plurality of quantum computing devices and a plurality of quantum simulator nodes, each quantum simulator node to simulate a different operating state for one of the plurality of quantum computing devices, the plurality of quantum computing devices and the plurality of quantum simulator nodes are each an execution node of the quantum computing network;
determine a selected execution node to execute the quantum service based at least in part on an operating state associated with the selected execution node; and
obtain a result for the quantum service executed at the selected execution node.

14. The computing device of claim 13, wherein each different operating state is associated with a parameter set for one of the plurality of quantum computing devices.

15. The computing device of claim 14, wherein the parameter set comprises data indicative of one or more of a number of qubits, qubit type, quantum error correction scheme, qubit load, or qubit noise profile.

16. The computing device of claim 13, wherein each quantum simulator node is implemented on one or more classical computing devices.

17. The computing device of claim 16, wherein the plurality of quantum computing devices and the plurality of quantum simulator nodes are connected in a mesh topology.

18. A non-transitory computer-readable storage medium having stored thereon computer-executable instructions that, when executed, cause one or more processor devices to:
receive data indicative of a quantum computing device joining a quantum computing network;
generate a plurality of quantum simulator nodes for the quantum computing device, each of the plurality of quantum simulator nodes to simulate one of a plurality of different operating states of the quantum computing device; and
store each of the plurality of quantum simulator nodes as an execution node of the quantum computing network to execute a quantum service.

19. The non-transitory computer-readable storage medium of claim 18, wherein the computer-executable instructions, when executed, cause one or more processor devices to:
monitor a first operating state for the quantum computing device for a first monitoring period;
generate a first simulator node associated with the first operating state for the quantum computing device;
determine a transition between the first monitoring period and a second monitoring period based at least in part on an occurrence of a threshold condition;
monitor a second operating state for the quantum computing device for the second monitoring period; and
generate a second simulator node associated with the second operating state for the quantum computing device.

20. The non-transitory computer-readable storage medium of claim 18, wherein the computer-executable instructions, when executed, cause one or more processor devices to:
create an operating profile of the quantum computing device joining the quantum computing network; and
communicate the operating profile of the quantum computing device to each of a plurality of nodes of the quantum computing network.
